(19) United States
(12) Patent Application Publication
(10) Pub. No.: US 2022/0167691 A1
(43) Pub. Date: Jun. 2, 2022

(54) Nose Only Mask

(71) Applicant: Tonsela Newton Watts, Riviera Beach, FL (US)

(72) Inventor: Tonsela Newton Watts, Riviera Beach, FL (US)

(21) Appl. No.: 17/467,108

(22) Filed: Sep. 3, 2021

Related U.S. Application Data
(60) Provisional application No. 63/103,978, filed on Sep. 3, 2020.

(51) Int. Cl. A41D 13/11; A62B 18/02

(52) U.S. Cl. CPC A41D 13/11; A62B 18/025

(57) ABSTRACT

The NOSE ONLY MASK is a specialty mask, designed to serve as a barrier that provides an added layer of protection needed WHILE you're eating, drinking, dusting/cleaning, smoking, during Dr's, dental, etc. appointments, etc. The NOSE ONLY MASK fits securely, and it leaves the mouth fully exposed to allow for eating, drinking, speaking, smoking, etc. freely.

A specialty mask, designed to serve as a barrier and to provide an added layer of protection WHILE you're eating, drinking, dusting/cleaning, during dental appts., etc. A mask that fits securely around the nose and it leaves the wearer's mouth fully exposed, to allow you to freely eat, drink, talk, sing, get dental work done, etc.

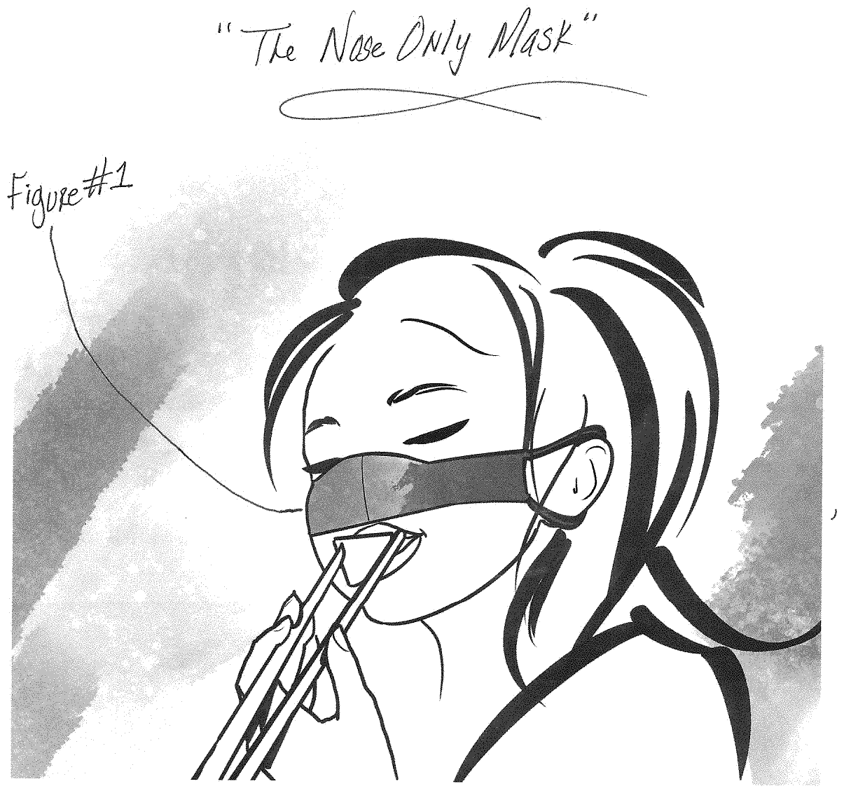

FIG. 1—Exhibits a picture of the mask and it shows the center of the mask that covers the nose securely, This figure also demonstrates one of many uses (eating) for the mask.

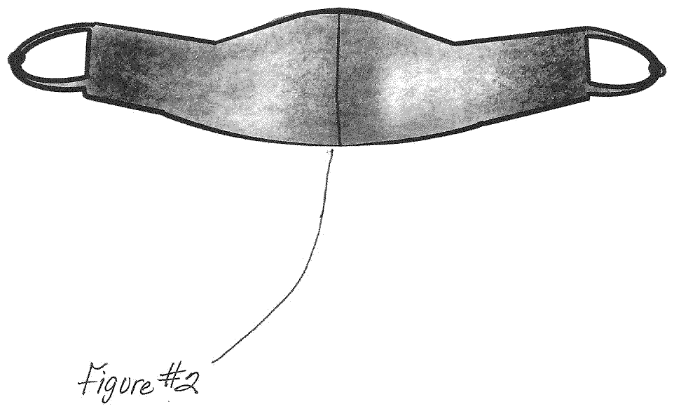

FIG. 2—Exhibits the area of the mask that rests above the wearers upper lip and underneath the nose, leaving the mouth fully exposed for eating, drinking, etc.

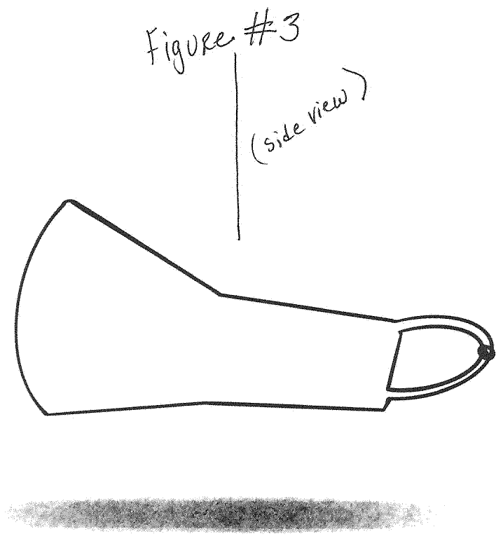

FIG. 3—Exhibits the side view of the mask

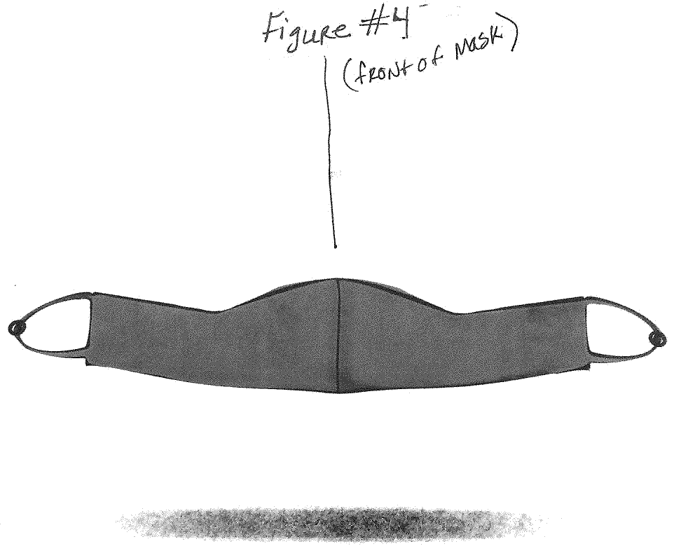

FIG. 4—Exhibits the front view of the mask

### BACKGROUND

God gave me the vision to create The Nose Only Mask back in June of 2020, shortly after the COVID 19 pandemic began. It's designed to give the wearer a sense of security and it adds an extra layer of protection while the said wearer is eating, drinking, cleaning, etc.

1. A nose only mask that gives the wearer an added layer of protection and allows you to eat & drink WHILE you're wearing it. This nose mask can be worn while you're cleaning, dusting, at dental appointments, etc.
